(19) United States
(12) Patent Application Publication
(10) Pub. No.: US 2015/0174434 A1
(43) Pub. Date: Jun. 25, 2015

(54) Chemical Protective Garment

(71) Applicants: Steven Christopher CONDON, West Lothian (GB); Donna Jane HERD, Edinburgh (GB); W.L. GORE & ASSOCIATES (UK) LIMITED, West Lothian (GB)

(72) Inventors: Steven Christopher Condon, West Lothian (GB); Donna Jane Herd, Edinburgh (GB)

(21) Appl. No.: 14/238,025

(22) PCT Filed: Aug. 3, 2012
(86) PCT No.: PCT/GB2012/051884

§ 371 Date: Jan. 28, 2015

(30) Foreign Application Priority Data
Aug. 10, 2011 (GB) 1113736.1

(51) Int. Cl. A62B 17/00

(52) U.S. Cl. CPC A62B 17/006

(57) ABSTRACT

A chemical protective garment, comprises a body (2) comprising a torso portion (10) and leg portions (14); removable arm sleeves (60); and optionally removable leggings (64). The body, removable arm sleeves and optional removable leggings being formed of chemically protective material.

The present invention relates to a chemical protective garment for protecting the wearer against noxious chemicals in the environment, usually in liquid and/or gaseous form. In particular, the protective garment may be used by military personnel as protection against attack by noxious chemical or biological (CB) threats.

Protective suits are known for protecting military personnel against chemical and/or biological threats. Such protective suits are generally formed of fabrics including either adsorbent materials, such as activated carbon or other chemical adsorbents, or barrier materials such as impermeable or selectively permeable membranes. Depending on the climatic conditions expected, the fabric may also be made waterproof to prevent water ingress. In order to achieve greater comfort and allow removal of perspiration from the wearer, such suits may also be formed of water vapour permeable material.

Conventionally protective suits are worn over the conventional battlefield dress uniform (BDU). This is because materials used in the suit are relatively thick, heavy and uncomfortable. Typically, the thickness of a battlefield dress uniform is around 0.3 millimetres and in contrast the thickness of a chemical protective suit, including adsorptive carbon layers, is in the region of 0.6-1.5 millimetres.

Consequently these materials are not desirable for use in an everyday wear protective suit and this means that such protective suits are more often carried than worn. Most militaries employ a staged approach to the wearing of such protective garments in order to minimise thermal burden and maximise readiness to attack. For example, at the lowest protection level, there is no threat of chemical attack and the user is wearing a conventional battlefield dress uniform (BDU) and is carrying the protective garment ensemble in a pack. At higher protection levels, the soldier dons the chemical biological (CB) protective ensemble in order to provide full protection against chemical and/or biological attack.

A typical chemical protective ensemble comprises an oversuit, gloves, over-boots, a hood (which is either integral to the suit or a separate item) and, a respirator which interfaces with the hood. Even when vacuum packed these items occupy several litres of volume and have an appreciable weight. When there is a risk of chemical and/or biological attack, the soldier is instructed to don the protective ensemble over his existing battlefield dress uniform. This involves donning the protective suit, gloves, over-boots, hood and respirator; resulting in an additional layer of clothing on top of the conventional battlefield dress uniform.

However, the protective ensemble donned over the conventional battlefield dress uniform imposes a significant additional thermal burden on the soldier, particularly in hot climates. The additional material layers increase the thermal insulation as well as creating additional air gaps, which further add to the insulation effect and impedes the escape of body heat. Moreover, the additional layers result in increased skin wettedness and reduced thermal comfort by impeding the transmission of water vapour through the garment.

Such protective oversuits are known in the art and are described, for example, in U.S. Pat. No. 4,117,552, U.S. Pat. No. 7,047,568, U.S. Pat. No. 7,062,788, U.S. Pat. No. 7,704,598, US2008/0216218, US2010/0319113 and WO2004/030764. Such garments may be one-piece garments or may be formed in two pieces (e.g. jacket and trousers) or three pieces (e.g. jacket, trousers and hood/respirator). Because of the additional thermal burden, such protective ensembles are not generally donned until it becomes necessary to do so but their additional weight is still a burden to the soldier as it has to be carried around.

There are also many suggestions in the literature for the construction of individual protective items, such as gloves and socks, (for example as described in U.S. Pat. No. 6,718,555, U.S. Pat. No. 7,451,497, US2006/0065353 and EP1738662). There are also many proposals in the patent literature dealing with the production of protective fabrics, used to form the chemical protective garment, for example WO01/41877, U.S. Pat. No. 7,704,598, US2003/0177566 and US2010/0212071.

Previous work has looked at the interaction of garment design and the physiological strain on human subjects wearing chemically protective garments. Some benefits have been found in introducing zippered vents in appropriate areas of the garment. This demonstrates the importance of design in potentially reducing the thermal burden of a chemical protective suit. A paper by entitled “Chemical-biological protective clothing: effects of design and initial state on physiological strain”, Mclellan T. M Aviation, Space and Environmental Medicine, Vol. 79, Number 5, May 2008 describes the physiological impact that can be achieved when incorporating zippered vents in chemical protective garments that are intended to replace non chemically protective combat fatigues.

Of course, it would be possible to incorporate the additional chemical biological protection into the conventional battlefield dress uniform but without the implementation of appropriate thermal burden reduction measures this would tend to render the uniform unnecessarily hot, bearing in mind that chemical or biological protection is only needed on rare occasions or in training situations.

Therefore, there is a need to provide military personnel with chemical and biological protection without imposing additional bulk and additional thermal burden on the soldier, and preferably at the same time minimising the weight of the additional protection.

The present invention is based on a novel approach to reducing the thermal burden presented to the wearer by providing permanent chemical protection only over certain parts of the body in everyday “dressed down” use, whilst leaving other important parts of the body free of protection and able to lose significant amounts of heat.

In particular, the present invention provides a chemical protective garment, which comprises

(a) a body formed of a chemically protective material and comprising:
a torso portion;
leg portions extending from the torso portion for covering either
(i) the legs of the wearer; or
(ii) part of each leg of the wearer;
   (b) removable arm sleeves also formed of chemically protective material and adapted to be fitted to the body;
   (c) where the leg portions of the body cover only part of each leg of the wearer, the garment further comprises removable leggings formed of chemically protective material and adapted to be fitted to a corresponding leg portion of the body; whereby the body, arms and legs of the wearer are protected by chemically protective material of the garment.

The invention also relates to a method of making the garment and also a method of protecting a wearer.

Thus, whilst the garment of the present invention can be worn over a conventional battlefield dress uniform, it is primarily intended to be worn in such a way as to replace the shirt and trouser part of the conventional battlefield dress uniform.

It is well known that significant heat loss from the human body occurs through the legs and arms, and also through the head. Therefore, leaving these areas free of any insulating covering maximises heat loss from the body or at least maximises the sensory perception of heat loss. In other areas, such as the torso, where heat loss or the sensory perception of heat loss is reduced, the existence of a bulky chemical protective fabric does not contribute so significantly to thermal burden or the sensory perception of thermal burden particularly as it is often covered by thick body armour which has a high thermal insulation value.

In addition to the benefits of significant heat loss from arms and legs as envisaged by embodiments of this invention there is also a further benefit due to reduced pack volume and weight that has to be carried. This means that only these additional chemically protective items need to be carried by the soldier rather than the full protective garment. When faced with a chemical or biological challenge, the wearer dons the removable chemically protective sleeves and other items, such as gloves, leggings, bootees and hood/respirator in order to complete the chemical biological protection. Such additional items are fairly easily donned in contrast to a coverall suit, which is sometimes awkward to don, particularly over conventional battlefield dress uniform.

As mentioned above, the soldier will normally continuously wear the garment body whilst carrying the removable sleeve and optional removable leggings in his pack. By using the chemically protective garment of this invention, the soldier is able to reduce the overall weight burden by the approximate weight of the non protective shirt and trousers conventional battledress uniform, for example, by up to a typical value of 1 to 2 kg.

The weight of the regular BDU fabric is typically in the range of 130 g/m² to 300 g/m² and the weight of chemically protective fabric is in the range of 150 to 500 g/m² (e.g. 250 to 400 g/m²).

The garment body is shaped for covering at least the torso and preferably the upper arms, leaving the lower arms and hands free. Normally, the soldier would wear the garment body in place of the conventional battlefield dress uniform shirt and trousers. The garment body may be designed as a short-sleeved uniform as sometimes worn by military in hot climates.

However, in preferred embodiments it may also be designed as a long-sleeved garment by extending the sleeves to the wrist with lightweight BDU fabric extensions or with fabric having improved thermal properties (and optionally lower chemical resistance) over that of the chemically protective material forming the garment body. In this way, the top part of the chemical protective garment may be designed to look equivalent to conventional battlefield dress uniform shirt, whilst at the same time providing good heat loss over the lower arms (and legs) which greatly contributes to the actual or sensory perception of heat loss. This makes the protective garment much more comfortable to wear. When a chemical or biological attack is imminent, the removable sleeve(s) (which may also be combined with a glove portion) are donned and fitted to the garment body, usually to the corresponding upper arm portion of the body portion(s) of the garment body, so as to complete the chemical protection of the protective garment. Removable leggings, where provided, are also donned and fitted to corresponding leg portions of the garment body.

The garment body may be provided with arm portions of chemically protective material extending from the torso portion at most to the middle of the forearm of the wearer, so that at least the lower half of the forearm of the wearer is not covered by the arm portion; so as to assist heat loss.

Alternatively, the garment body may be in the form of a gillet (without arm portions). In this case the removable sleeve is fitted directly on to the body of the garment.

The arm portions of the garment body extend from the torso portion of the garment body at most to the middle of the forearm. Generally, the arm portions extend at least a short way from the torso portion so as to provide an overlap region, where the removable sleeve may be fitted to the arm portion in overlapping relationship. The removable sleeve is usually on the outside, but can underlie the arm portion, particularly when ingress of chemical in liquid form is to be avoided. In other embodiments, the arm portion extends down to just above the elbow, finishes at the elbow, or just below the elbow. However, it is preferred to leave as much of the upper arm and forearm of the wearer free of said garment arm portion (formed of protective material) as is practicable so as to allow for maximum heat loss of the wearer, and commensurate with suitable appearance.

In the same way, the leg portions of the chemically protective body partially cover the wearer's legs or may be full length. In a preferred embodiment, the leg portions cover only the upper legs (or the upper part thereof), leaving the lower legs free. The lower end of the garment body may be designed in the form of shorts, which may be acceptable in some militaries in some climates. Alternatively, in analogous fashion to the sleeves, the leg portions of the garment body may be extended to full length using extensions of a fabric of improved thermal properties (and optionally lower chemical resistance) than the chemically protective material. The garment has the appearance of having long trousers, whilst at the same time allowing good heat loss from the extensions formed of a material having improved thermal properties compared to the chemically protective material, for example conventional battlefield dress uniform fabric. Removable leggings formed of chemically protective material (and optionally including chemically protective bootees) may be provided for donning in the event of chemical or biological emergency.

Preferably, the arm extensions and/or leg extensions are formed of a fabric which visually matches the appearance (e.g. camouflage pattern) of the garment body, so as to minimise any visual discontinuities between the chemically protective material and the extensions. For example, the same face fabric can be used for both the chemically protective material and the fabric of the extensions.

The material of the arm/leg extensions is selected to provide improved thermal properties compared to the chemically protective material. Often, the material of the arm/leg extensions will be of lighter weight than the chemically protective material.

Although not preferred, it is possible for the arm/leg extensions also to be formed of a chemically protective material, but with the proviso that it has improved thermal properties compared to the chemically protective material of the body. For example, the R_{ct} or Rₑₜ or air permeability of the extensions should preferably be at least 1.2 times, three times or five times better than the value for the material of the garment body. In this case the chemically protective capability of the removable sleeves/leggings which overlie the arm/leg extensions may be reduced in correspondence to the additional chemical protection afforded by the chemically protective material of the arm/leg extensions.

The definition as described herein of “improved thermal properties” of a fabric or material over that of another, is where the improved fabric or material possesses one or more of the following performance benefits:
Lower thermal resistance R_{ct} (K·m²/W) as tested to ISO 11092: 1993. Typical values of thermal resistance of a textile face fabric only range from 5 to 20×10⁻³ K·m²/W and when combined with a chemically protective non membrane material this will typically be in the range from 15 to 50×10⁻³ K·m²/W.)
Lower evaporative resistance Rₑₜ (m²·Pa/W) as tested to ISO 11092: 1993.

Typical values of a conventional textile face material are in the range of 2 to 5 (m²·Pa/W). Typical values of evaporative resistance of a chemically protective non membrane material with textile face fabric range from 4 to 15 (m²·Pa/W).)
Higher air permeability (I/m²/s) as tested to ISO 9237: 1995. Typical values of a conventional textile face material for use in a BDU shirt or trousers is in the range of 100 to 300 I/m²/s @100 Pa.
   Typical values for a chemical protective material range from 0 to 300 l/m² sec @ 100 Pa depending on whether a membrane layer is included, the closeness of face fabric weave and density of the adsorbtive material. Typical values for a woven face fabric as used in a CB protective material are 20 to 100 l/m²/sec.

In this way, the body portion of the chemical protective garment of the present invention may be designed to either look like a short-sleeved shirt-and-shorts combination (for use in appropriate military circumstances) or may be designed to look like a conventional battlefield dress uniform having long sleeves and long trousers. However, since the body is formed of a chemically protective material, whilst the lower arm portions and optionally lower leg portions are merely covered by a fabric of lower thermal resistance, the thermal burden imposed is much less than for conventional protective suits.

The body portion can be a one-piece portion or can be split at the waist into a shirt portion and a short trouser portion. When provided as a one-piece body portion, it may be tailored so as to appear to have a waist band. It may also be provided with other conventional facilities, such as an openable fly.

The soldier will normally continuously wear the garment body, whilst carrying the removable sleeve and optional removable leggings in his pack.

The removable sleeves and removable leggings may be fitted to the corresponding positions on the garment body. Generally, the sleeve and leggings overlap corresponding respective areas on the garment body, so as to provide a double layer of chemically protective material, which assists adsorption of any noxious chemicals passing between the two. In order to avoid liquid ingress, it is preferred that the removable sleeves and removable leggings fit underneath the corresponding part of the garment body. The sleeves and leggings are preferably secured in place by conventional fastening means, such as Velcro (trade mark) hook and loop fabric tapes or straps, buttons, zip fasteners, press studs etc. This allows the removable sleeves and leggings to be donned and fitted quickly.

The chemical protective garment of the present invention is able to be donned quickly in the event of an attack and gives good short term protection, whilst the wearer seeks safety. Usually, the chemically protective BDU garment will be designed to provide up to 2 hours or 6 hours or 12 hours protection and in some cases up to 24 hours. At least for adsorptive chemical protective suits (including carbon or other absorbents) it may not be necessary to have perfect chemical-resistant seals between the body and the removable sleeves/leggings, although it may be desirable to introduce overlaps at these interfaces to increase the adsorptive effectiveness for vapour or liquid chemicals. For non-adsorptive chemical protective barrier materials it may be necessary to attach the removable sleeve and leggings to the body with a vapour or liquid tight seal.

As mentioned above, the sleeve can be formed integrally with a glove also formed out of chemically protective material. The leggings can be integrally formed with a bootee also formed of chemically protective material.

Alternatively, the glove and bootee can be formed separately and fitted to the sleeves or leggings respectively in analogous manner, as set out above.

In order to minimise thermal burden, it is preferred that the removable sleeve meets the body in the region above the elbow. If the arm portion is extended down to the wrist using a fabric of improved thermal properties, such as BDU fabric, it is relatively easy for the soldier to roll up the sleeves when he feels hot. Because the BDU fabric is generally more light-weight than the chemically protective material, rolling up the sleeves is easily accomplished, whereas it is generally difficult or impractical to do so in the case of the relatively bulky chemically protective material.

Similar comments apply to the leggings. The chemically protective removable leggings are generally fitted to the leg portions at a position above the knee. This enables the lower end of the garment body to be designed in the form of a pair of shorts. It also allows long trousers extended using fabric of improved thermal properties to be rolled up above the knees to maximise thermal loss. Alternatively, the removable leggings could be fitted to the chemically protective leg portion below the knee.

Pockets and pouches may be provided on the arm portions and leg portions of the garment body for holding equipment. Relocating these pockets and pouches from their conventional position on the torso also helps minimise thermal burden.

In the present invention, generally the garment will be symmetrical. In other words, the design of each arm covering will be the same on each side; and the design of each leg covering will be the same on each side. However, they could be different.

Generally, a protective hood will be provided also, formed of chemically protective material. The purpose of the hood is to provide chemical protection around the head and also to seal to the periphery of the respirator. The respirator and hood can be formed in a single unit or may be provided separately to be fitted together. When the hood is separate from the respirator, the hood may form part of the garment body or it may be separate. In a preferred embodiment, the hood is provided with a cowl surrounding the neck and sitting on the wearer's shoulders. Preferably, this cowl fits underneath the corresponding neck area of the body of the garment, so that there is overlap between the chemically protective material of the body and the chemically protective material of the cowl. Conventional fastening means as described above may be provided to fit the hood to the body. However, in a preferred embodiment, the body is provided with a neck portion which goes over the cowl of the hood and secures it in place. The neck portion of the garment body may be provided with a zip closure or other closable opening, which secures the neck portion in place above the cowl. The overlapping region of chemically protective material provides a good short term barrier to ingress of noxious chemicals. Alternatively, the collar region of the body portion could be extended using fabric having improved thermal properties.

In an alternative embodiment, the cowl of the hood fits on the outside of the neck portion of the body portion of the garment. If non-sorptive barrier materials are used then an effective vapour seal may be required for the interface between the hood and the body.

Protective suits are known for protecting military personnel and other hazardous occupations against chemical and/or biological threats. Various types of chemical protective suits are available which have differing levels of comfort and protection performance depending on the type of protective materials used and the design of suit manufacture. Some chemical protective materials are air and water vapour permeable and these typically utilise adsorbents such as activated carbon within the protective material structure, others that are not air permeable include a barrier layer for hazardous substances but are water vapour permeable for additional comfort, and are often termed semi-permeable barriers, while yet other protective materials include barrier layers that are impermeable to hazardous substances as well as non hazardous substances such as water vapour.

The chemically protective material of the garment body can be any suitable material known in the art, and is preferably a chemically protective fabric. In a preferred embodiment, the chemically protective fabric includes a layer of adsorptive carbon or other absorptive substance for absorbing noxious chemicals. In one embodiment, the chemically protective fabric comprises an outer face fabric, facing away from the wearer, and a carbon impregnated knit layer either laminated to the face fabric or hanging loosely inside the face fabric. A liner is positioned or laminated on the inside of the carbon impregnated layer. The liner is usually a knit fabric. If waterproofness and water vapour permeability are desired, a waterproof semi-permeable membrane of a type known in the art may be positioned on the inside of the face fabric and between the face fabric and the absorbent layer. Alternatively, a treatment may be applied to the face fabric to render it water repellent.

The adsorptive materials may comprise activated carbon in the form of powders, granules, fibres, beads and the like. Activated carbon is the generic term used to describe the family of carbon adsorbents with a highly crystalline form and extensively developed internal pore structure. The pores in activated carbon have been classified as macropores (radius greater than 25 nm), mesopores (radius 1 to 25 nm) and micropores (radius less than 1 nm). Activated carbon may be combined with at least one other functional material to provide against biological and chemical agents. These may include metal oxides, metal complexes of hydroxides, metal hydrates and polyoxometalates. In addition to such functional materials, there can also be dispersed at least one additive selected from the group consisting of flame retardants, anti-microbial additives, antioxidants, UV absorbers, hydrophobic materials, etc. The carbon adsorptive layer may include from 10 to 200 grams of carbon per m², particularly 50 to 100 grams per m². A wide variety of activated carbon fabrics are available exhibiting markedly different characteristics depending upon the raw material and activation technique used in their production.

Where a waterproof water vapour permeable membrane is included in the chemical protective fabric, it generally has a moisture vapour transmission of (MVTR) of 2000 g/m²/day to 60,000 g/m²/day (method as per U.S. Pat. No. 4,862,730 using potassium acetate). Microporous films suitable for use in the present invention include microporous fluoropolymers e.g. polytetrafluoroethylene (PTFE), expanded polytetrafluoroethylene (ePTFE), tetrafluoroethylene/hexofluoropropylene copolymers etc. Suitable expanded PTFE films are described in U.S. Pat. No. 3,953,566, U.S. Pat. No. 4,187,390 and U.S. Pat. No. 4,194,041.

Alternatively, the chemically protective material may be a barrier material, such as an impermeable or semi-permeable membrane, as described above.

Where the garment is also to provide biological and/or radiological protection, it is preferably arranged to withstand particulate penetration. A closely woven face fabric can be utilised to exclude a range of particle sizes, and in addition a vapour permeable microporous membrane may be included as a layer in the chemical protective material to further extend the level of biological and particulate protection. Particles include aerosols, biological agents and radiological particles. Relevant particle sizes, are commonly for example, in the range of 0.04 to 400 microns.

In this way, a preferred embodiment of the present invention provides a chemical protective garment where the chemically protective body covering the torso may be worn in place of the conventional everyday battlefield dress shirt and trouser uniform and provide a uniform appearance, whilst at the same time leaving at least the lower arms and lower leg portions relatively unencumbered and without undue thermal burden. This provides relatively comfortably “dressed down” everyday wear. Should a chemical or biological emergency arise, the chemically protective sleeve and leggings may be quickly donned and fitted in place to provide complete chemical protection; together with gloves and/or bootees as appropriate (“dressed up”). The hood and respirator are also donned. The amount of additional equipment which requires to be carried by the soldier in order to meet chemical or biological challenge is reduced to removable sleeves (optional including glove portions), removable leggings (optional including bootee portions) and hood/respiratory combinations. However, these removable items can be donned rapidly and more easily than a conventional one-piece protective suit.

Embodiments of the present invention will now be described by way of example only in conjunction with the attached drawings wherein:

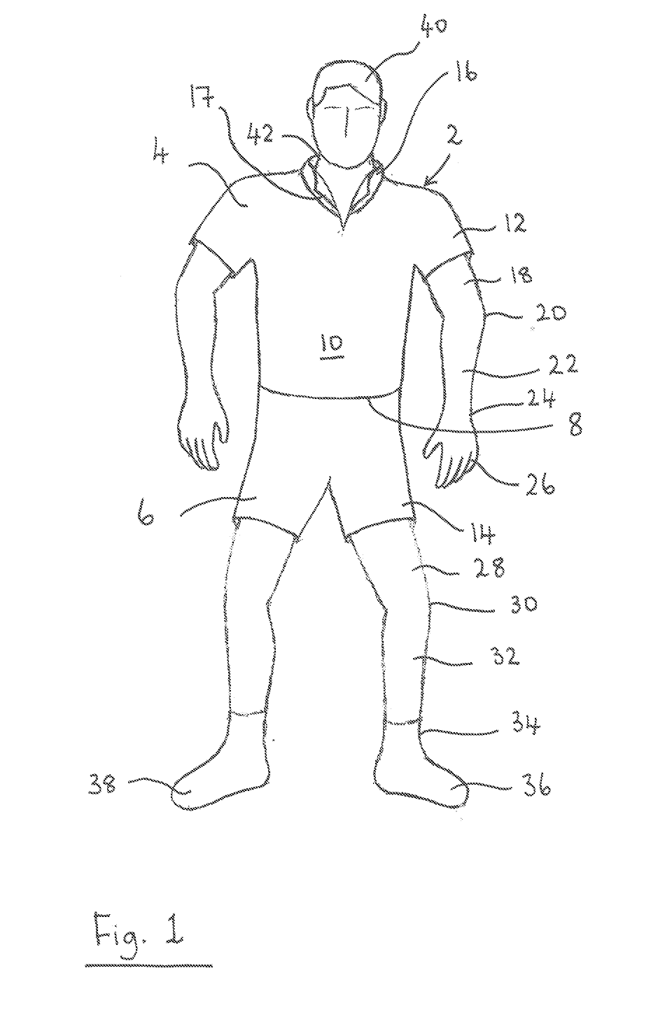

FIG. 1 shows in one embodiment, the body of a chemical protective garment according to the present invention;

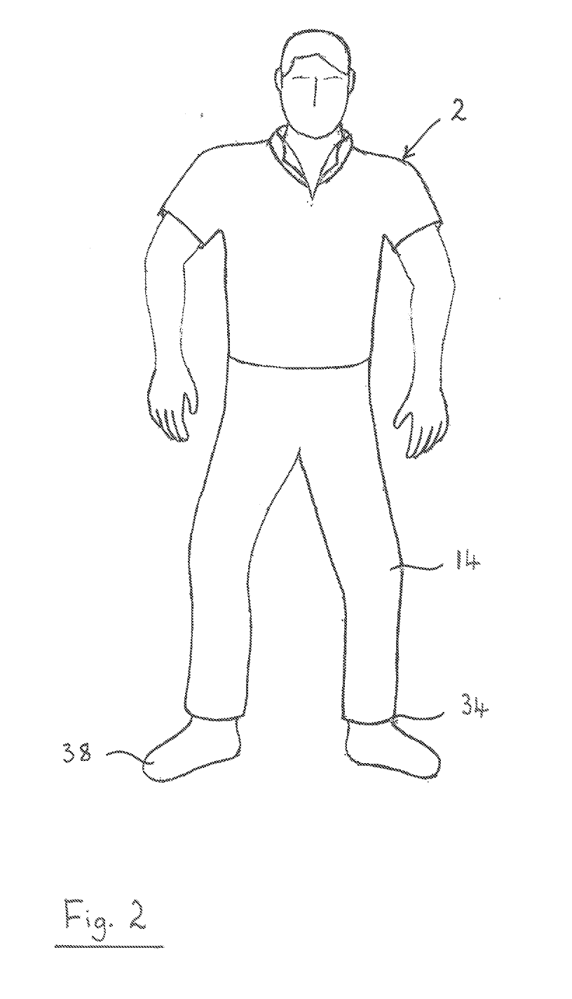

FIG. 2 shows in a second embodiment, the body of a chemical protective garment according to the present invention, wherein the leg portions of chemical protective fabric extend down to the ankle;

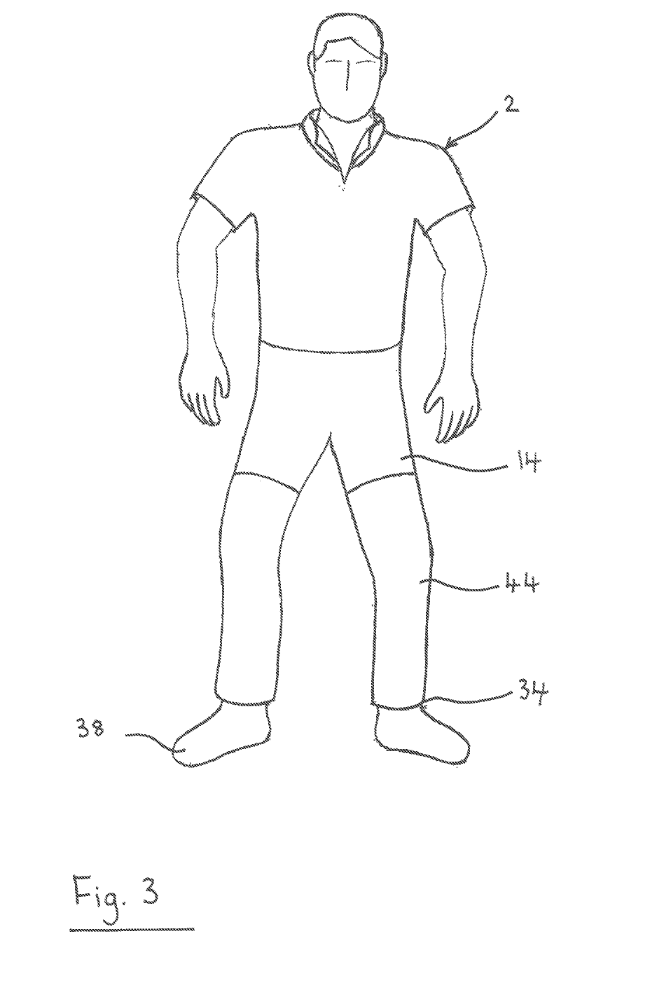

FIG. 3 shows in a third embodiment, a body of a garment according to the invention including leg extensions in fabric with improved thermal properties e.g. conventional BDU fabric.

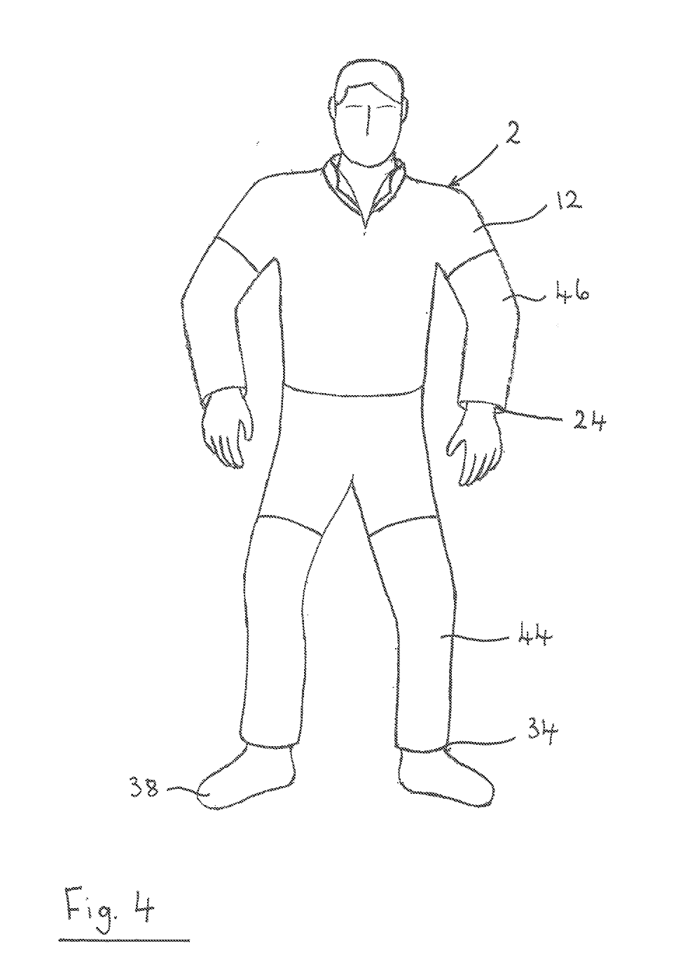

FIG. 4 shows in a fourth embodiment, a body of a garment according to the present invention comprising both leg extensions and arm extensions in fabric with improved thermal properties e.g. BDU fabric;

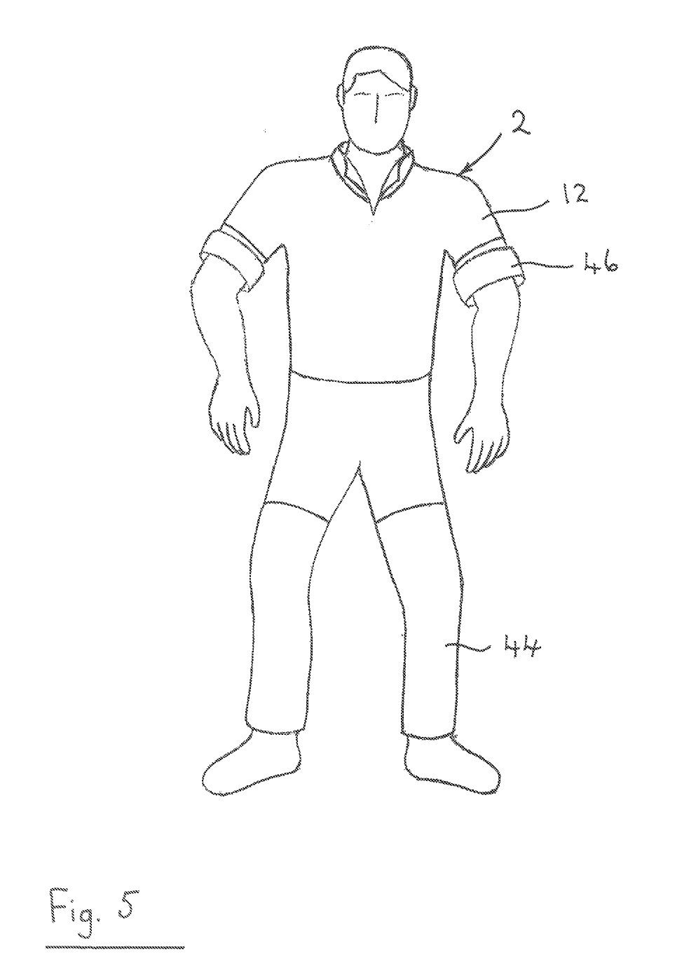

FIG. 5 shows the fourth embodiment, wherein the arm extensions have been rolled up above the elbow;

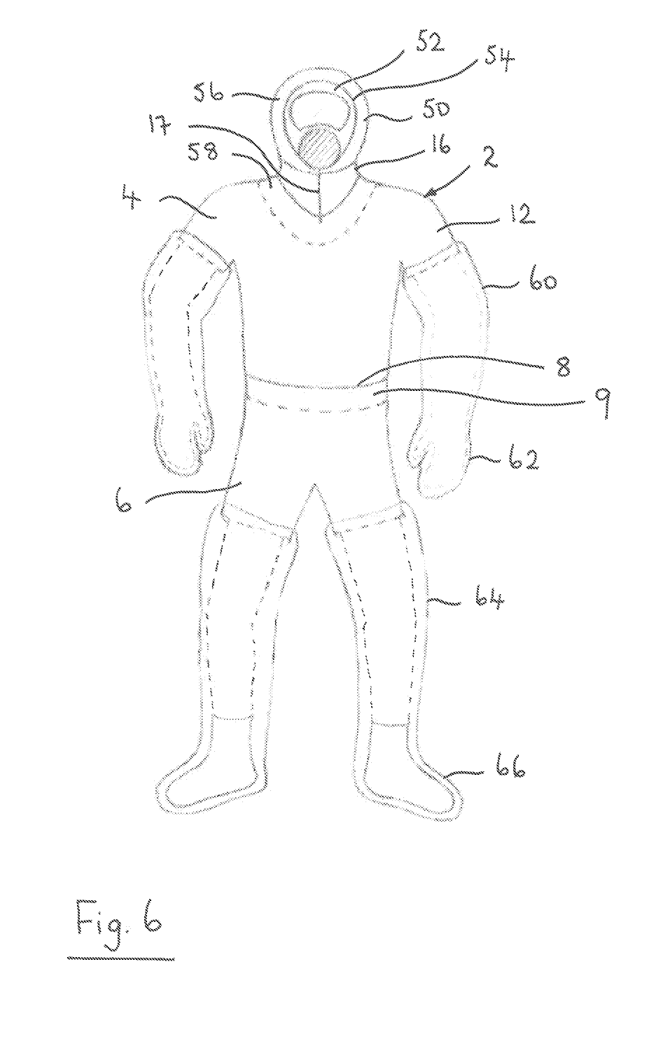

FIG. 6 shows a chemical protective garment according to the present invention which includes the body of FIG. 1, together with removable sleeve/glove combinations and removable leggings/bootee combinations, and a hood;

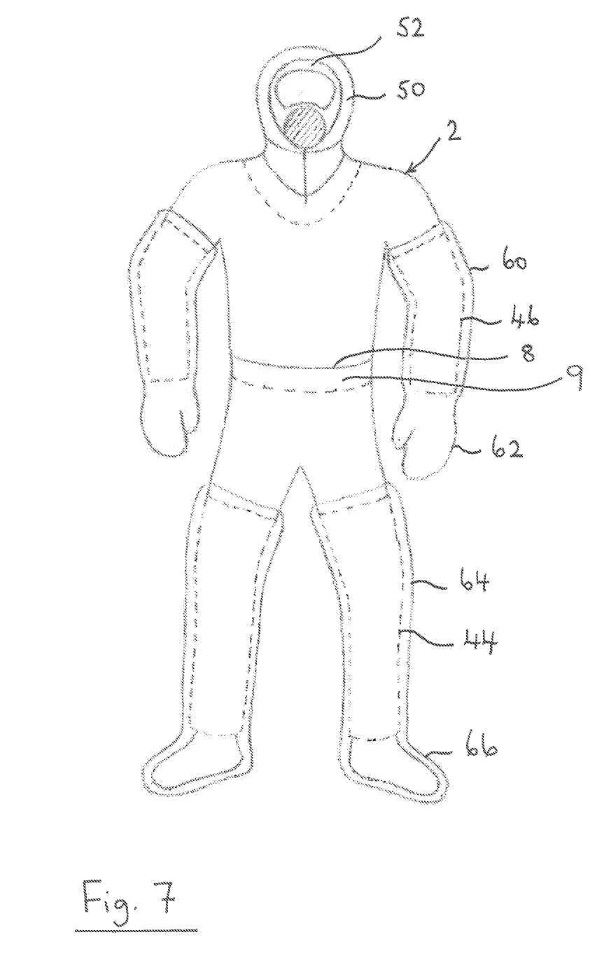

FIG. 7 shows a chemical protective garment which includes the body of FIG. 4, together with removal sleeve/glove combinations of chemically protective fabric and removable leggings/bootee combinations of chemically protective fabric, and a hood;

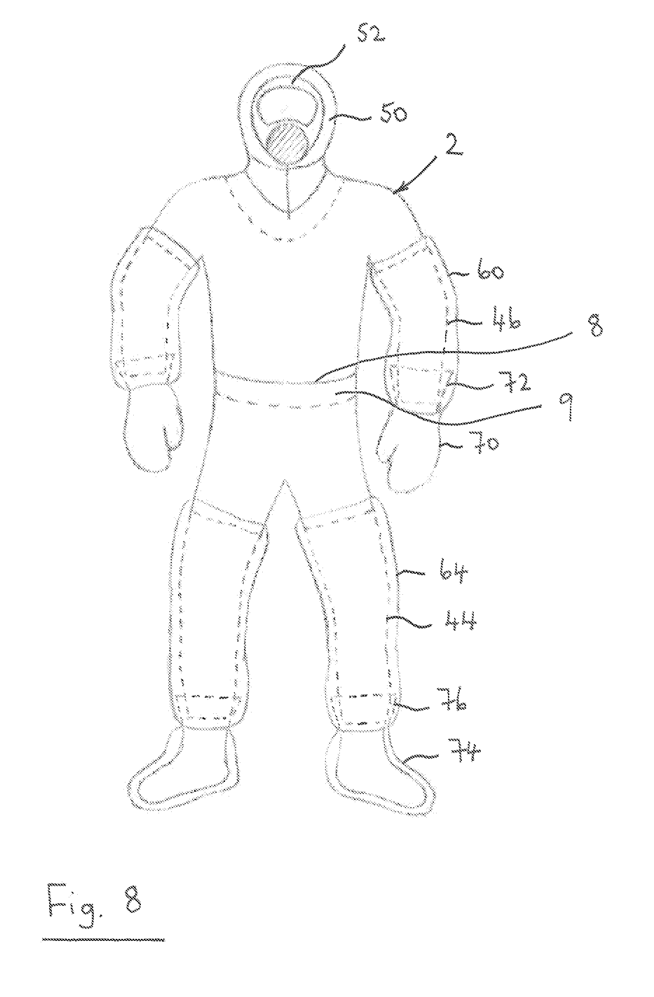

FIG. 8 shows a chemical protective garment, which includes the body of FIG. 4, together with removable sleeves of chemically protective fabric and separate gloves; and removable leggings of chemically protective fabric together with separate bootees, and a hood;

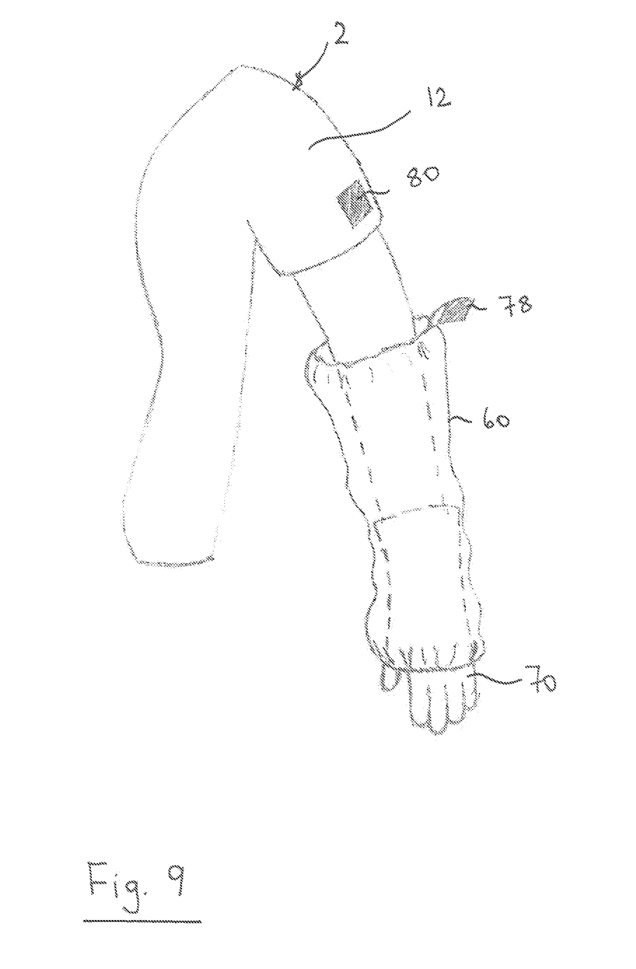

FIG. 9 is a detailed view showing the donning of a removable sleeve;

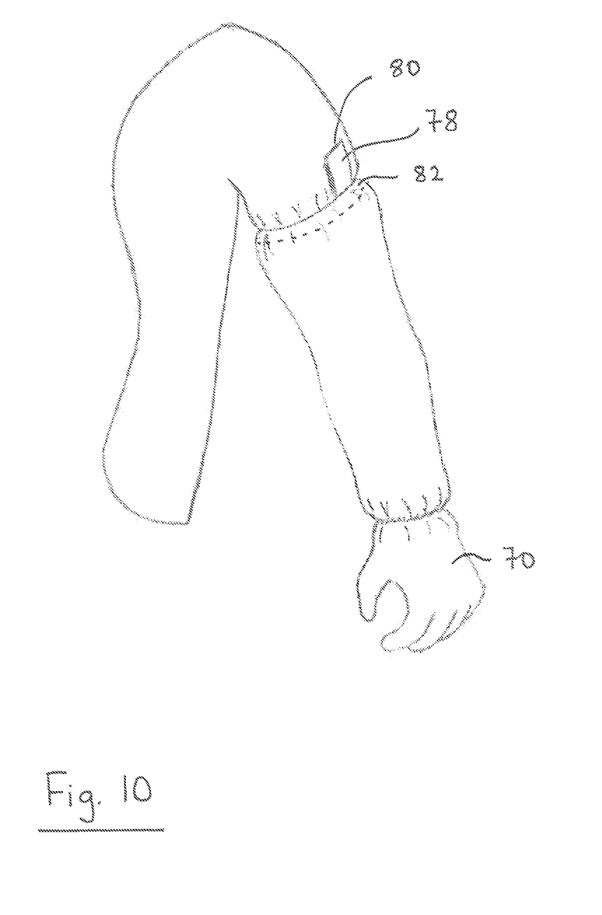

FIG. 10 shows the same view as FIG. 9 with the removable sleeve fitted in place;

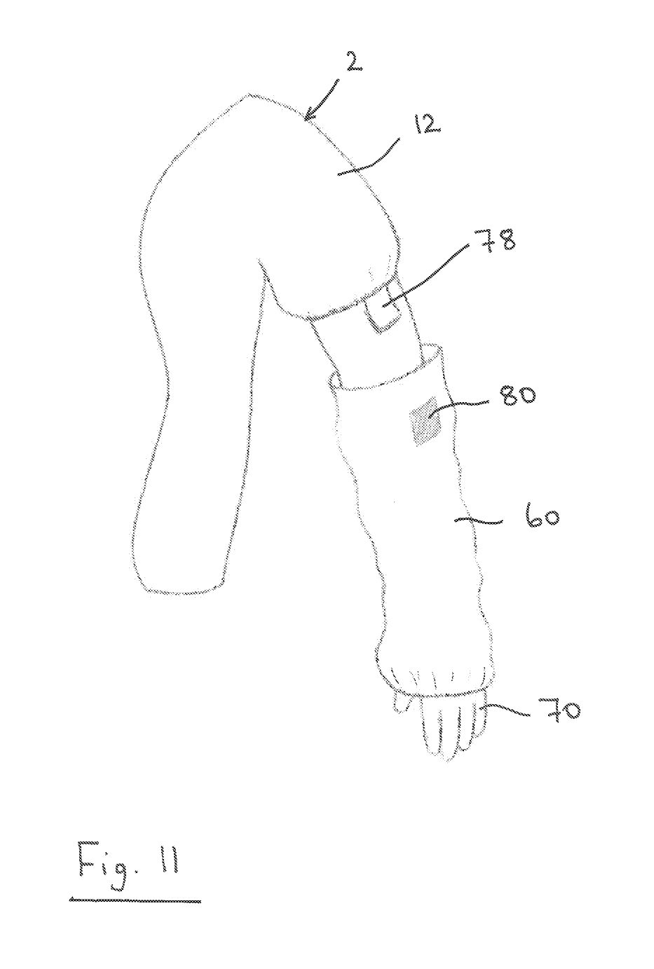

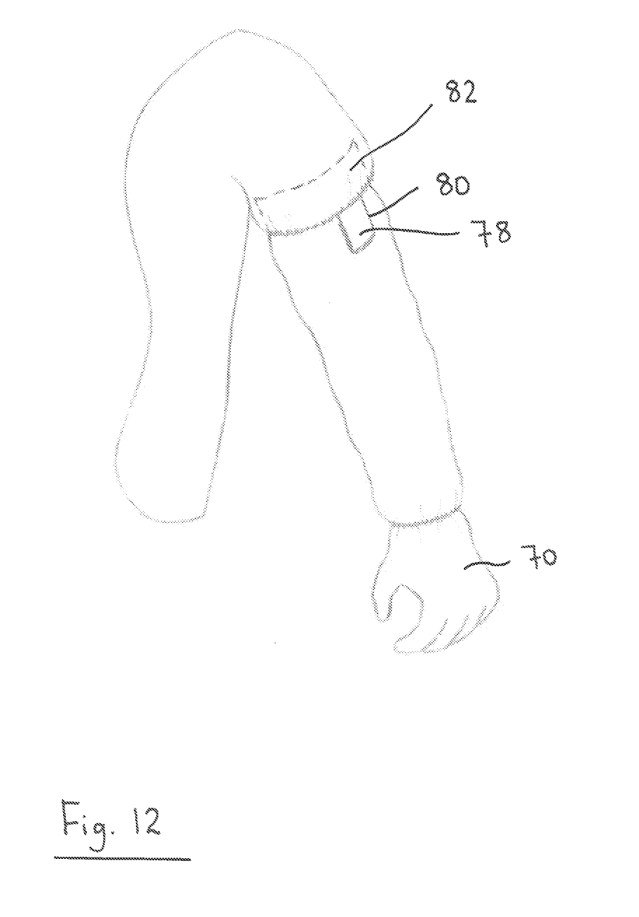

FIGS. 11 and 12 show an analogous embodiment to FIGS. 9 and 10, but where the removable sleeve fits under the arm portions of the garment body;

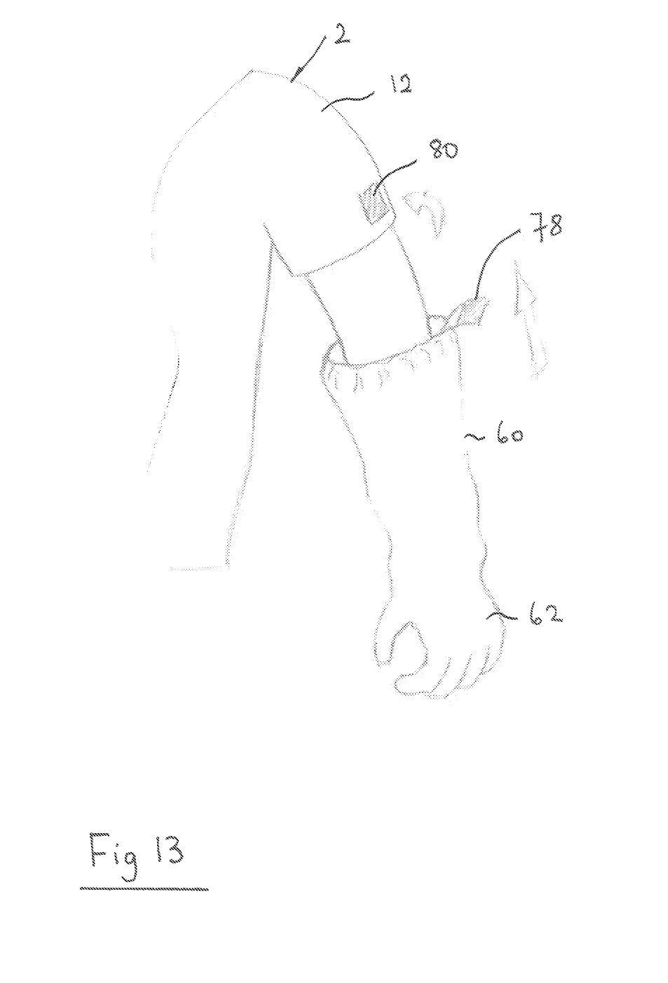

FIG. 13 shows the donning of a removable sleeve/glove combination of the embodiment shown in FIG. 6;

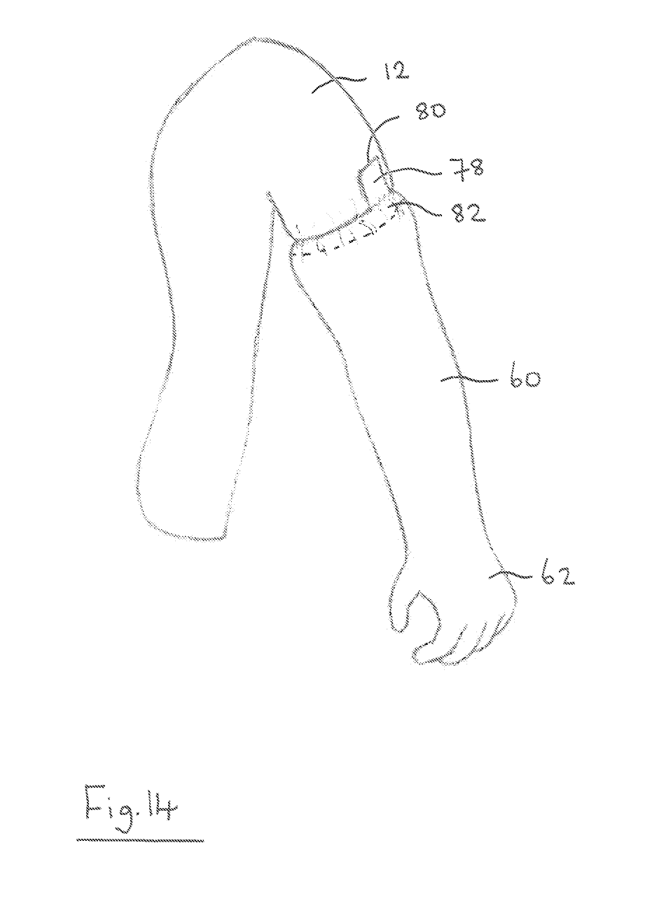

FIG. 14 shows the sleeve/glove combination of FIG. 13 fitted in place;

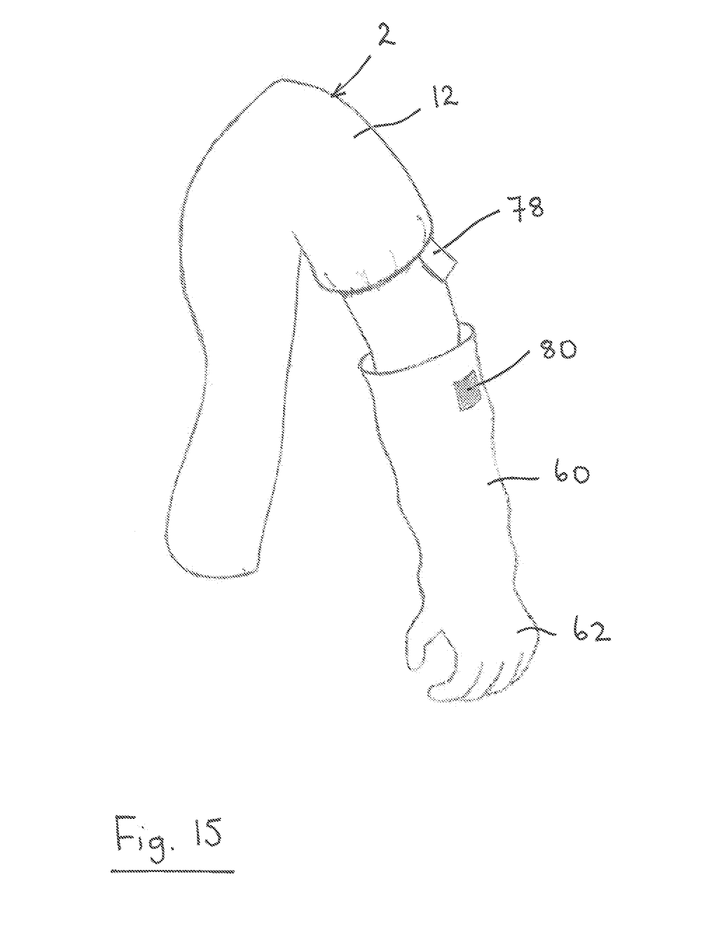

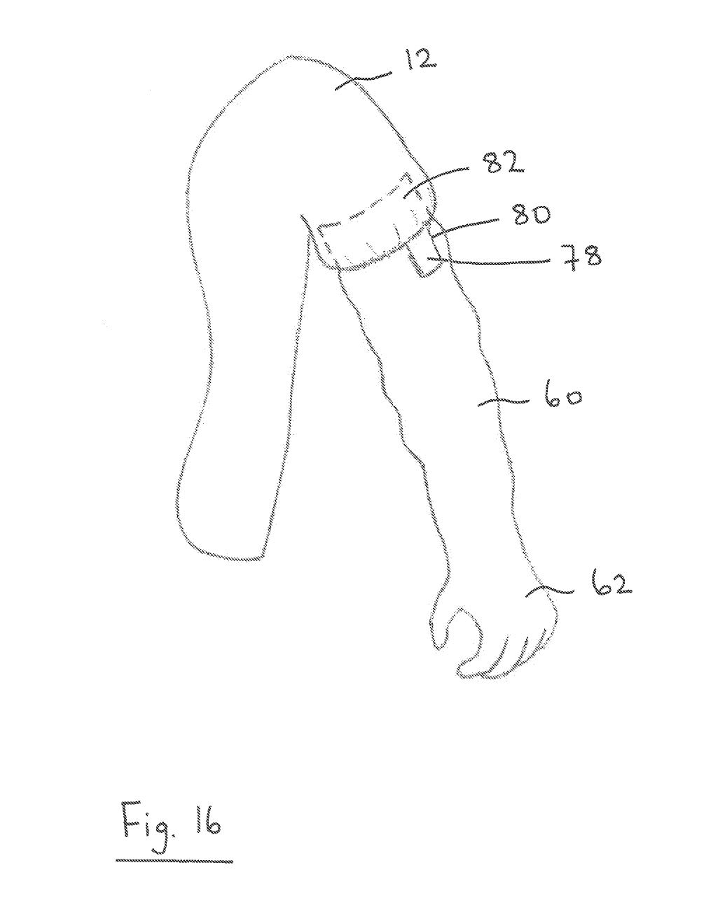

FIGS. 15 and 16 show an analogous embodiment to FIGS. 13 and 14, but where the removable sleeve fits under the arm portions of the garment body;

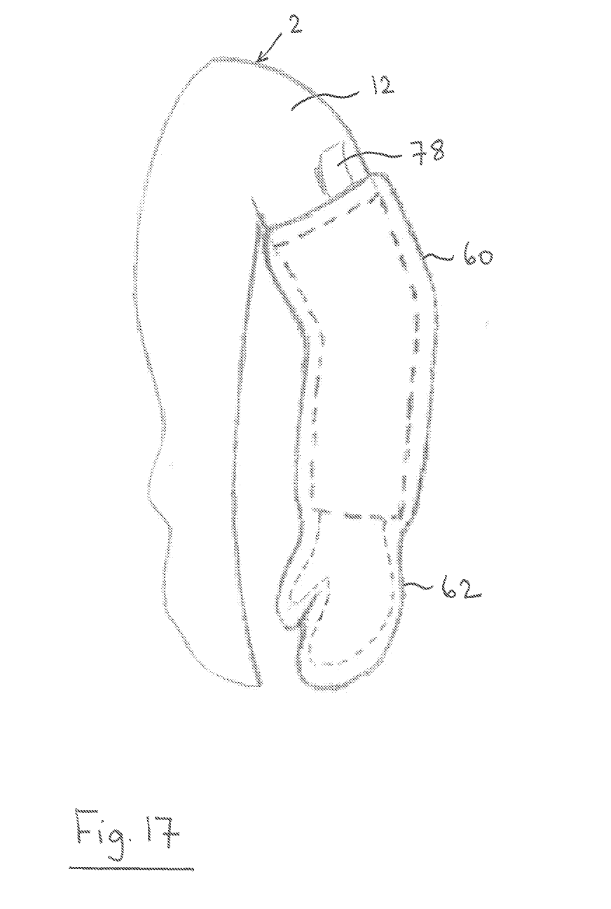

FIG. 17 is a detailed view of the removable sleeve of FIG. 7 fitted in place;

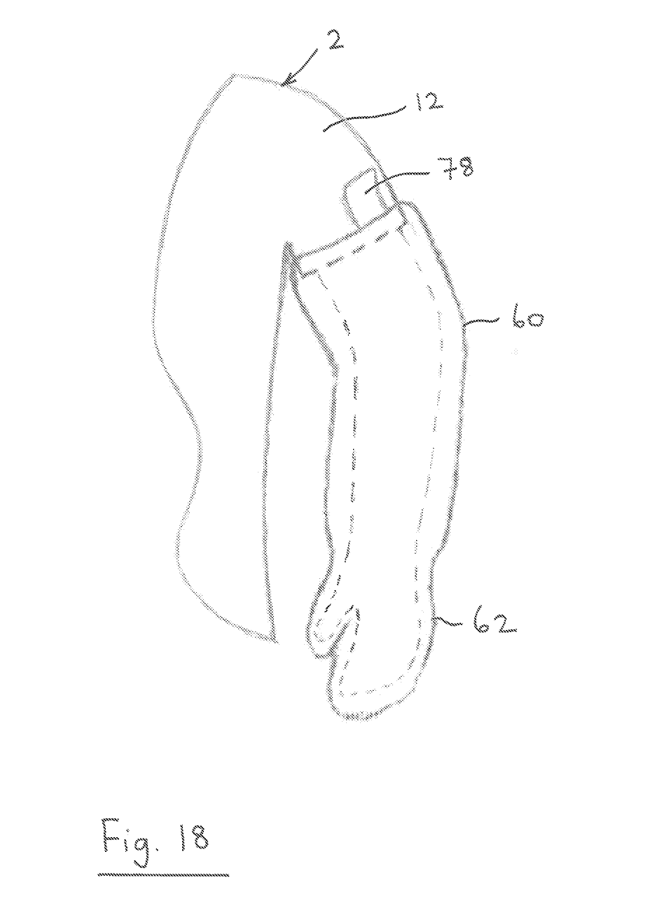

FIG. 18 is a detailed view of the removable sleeve of FIG. 6 fitted in place;

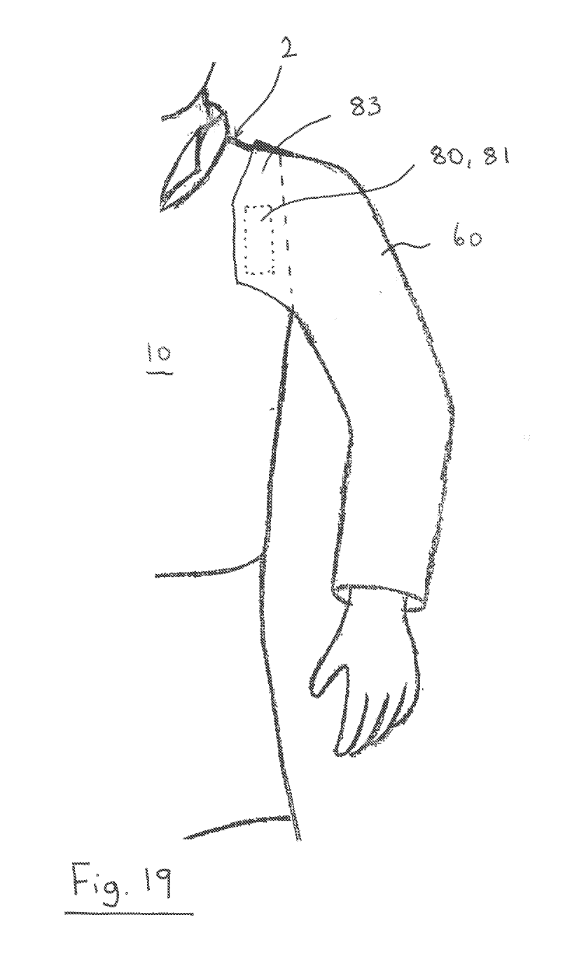

FIG. 19 is a detailed view of a removable sleeve fitted directly to the torso portion of the garment body, according to a further embodiment;

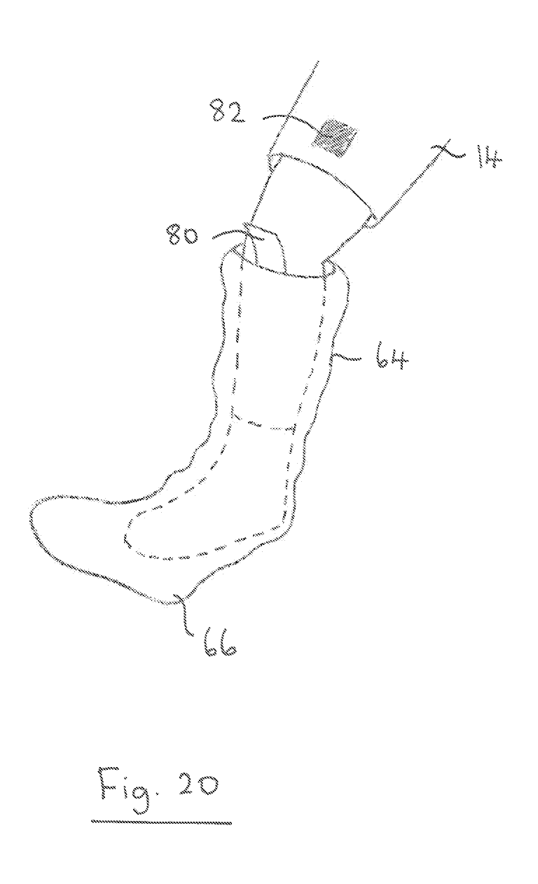

FIG. 20 is a detailed view of leggings/bootee combination of chemically protective fabric of FIG. 6 in the process of being donned;

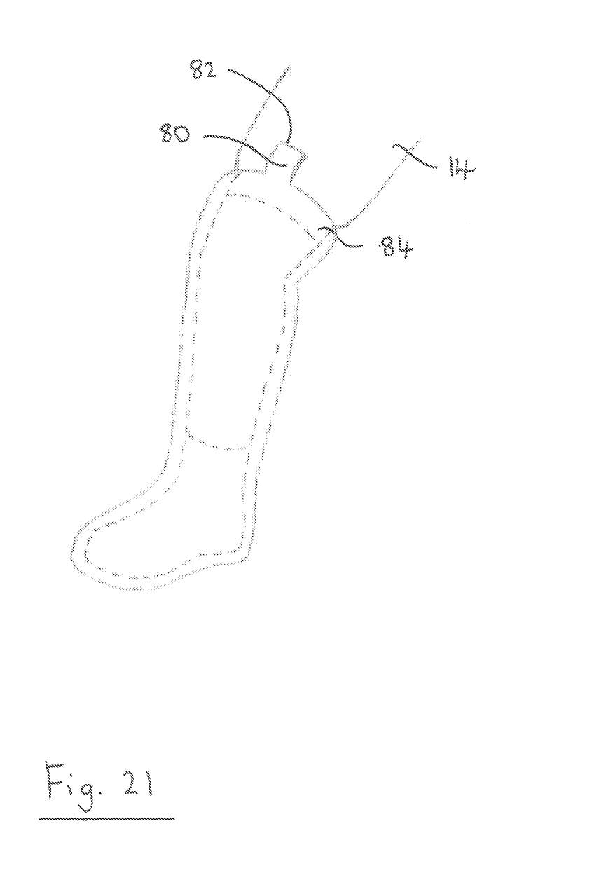

FIG. 21 shows the leggings/bootee combination of FIG. 20 fitted in place;

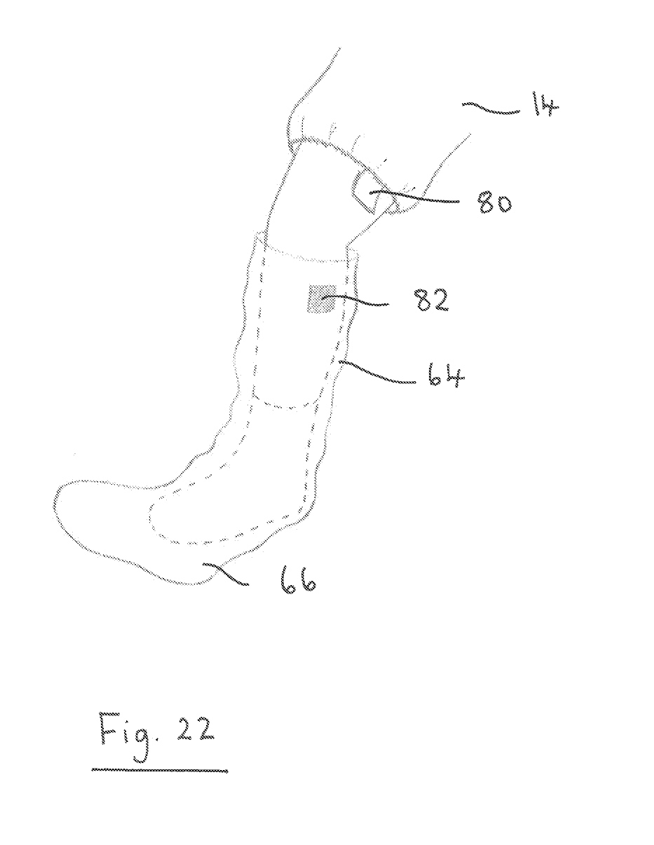

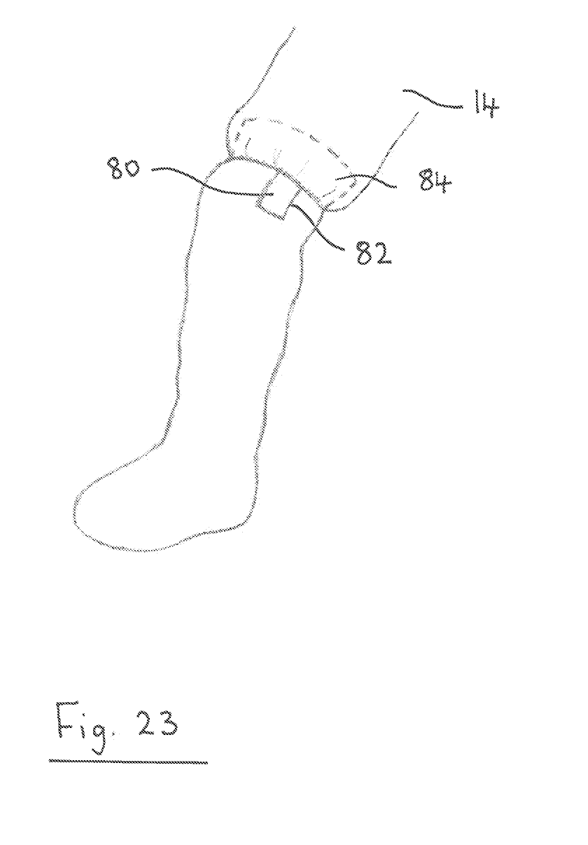

FIGS. 22 and 23 show an analogous embodiment to FIGS. 20 and 21, but where the removable leggings fit under the leg portions of the garment body;

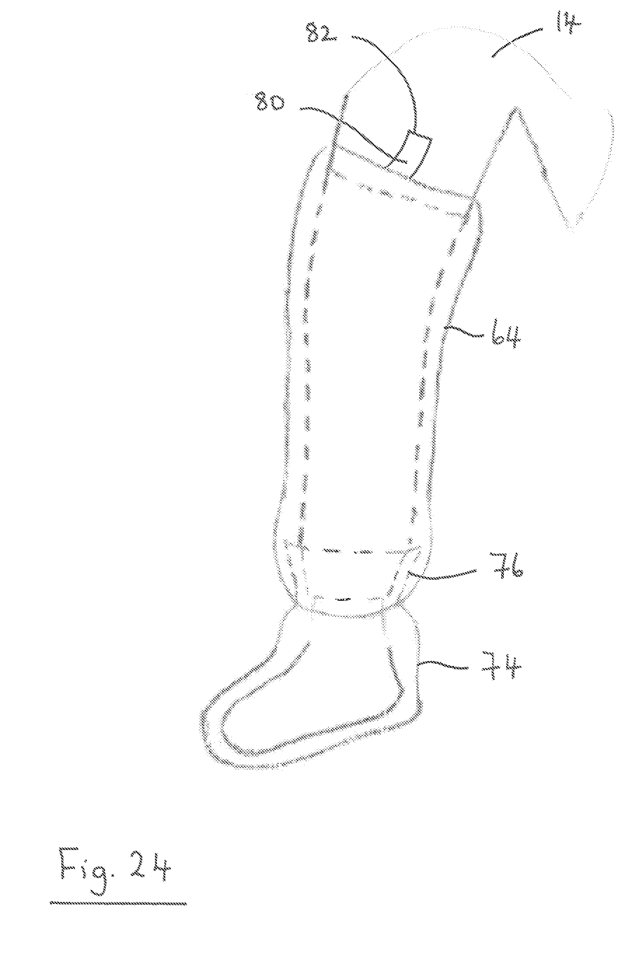

FIG. 24 is a detailed view of the leggings of FIG. 8;

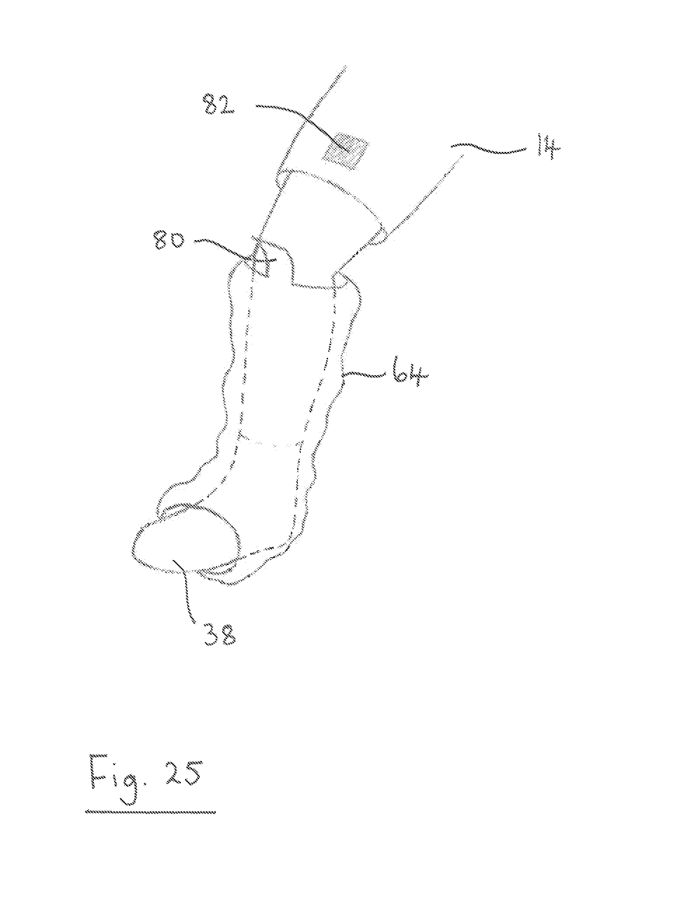

FIG. 25 is a detailed view of the donning of leggings in the absence of a boot or bootee; and

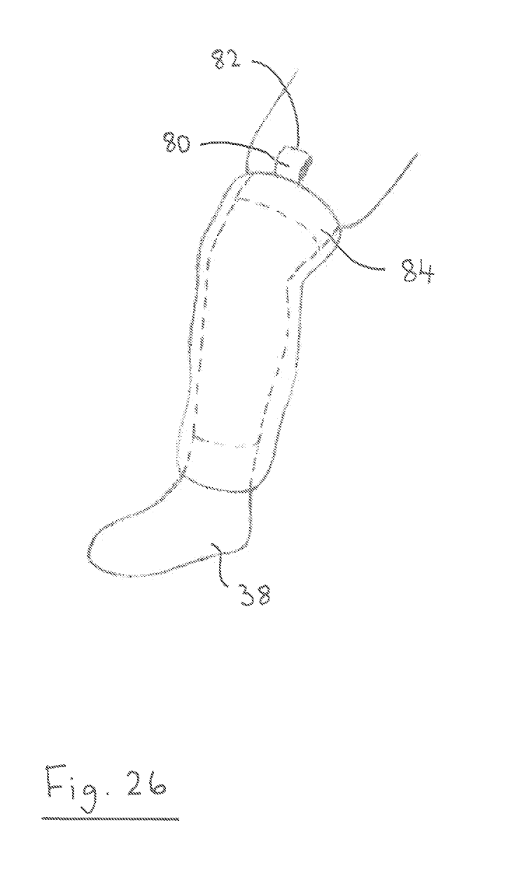

FIG. 26 shows the leggings of FIG. 25 fitted to the leg portion; and

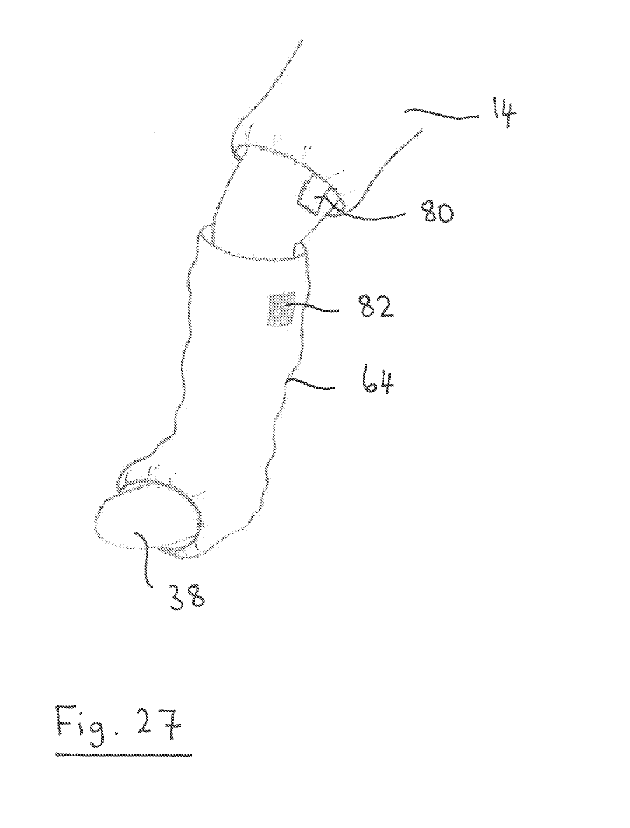

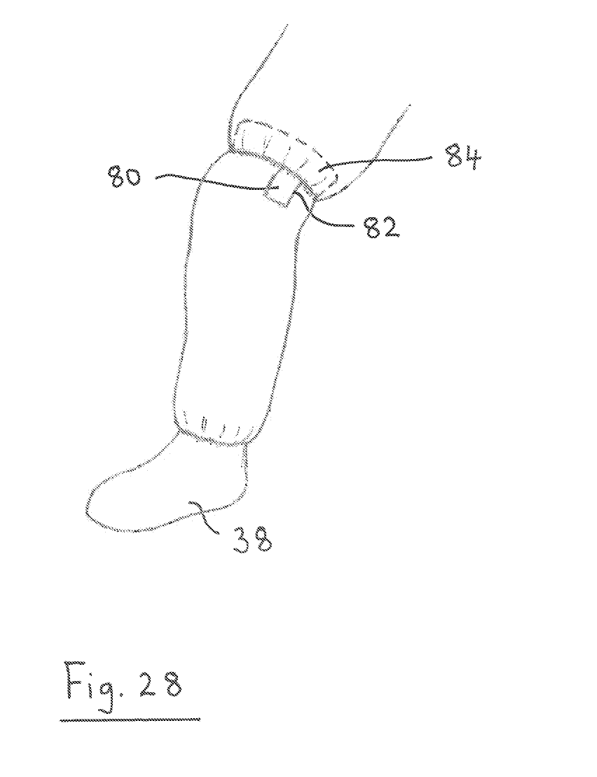

FIGS. 27 and 28 show an analogous embodiment of FIGS. 25 and 26, but where the removable leggings fit under the leg portions of the garment body.

In the figures, analogous parts are indicated by the same reference numerals.

FIGS. 1, 2, 3 and 4 respectively show four embodiments of bodies of chemically protective garments according to the present invention. In order to complete the overall protective garment, chemically protective removable sleeves/gloves, leggings/bootees, hood need to be fitted to the body of the garment. A respirator is worn to complete the protective ensemble.

The garments may also be provided with sealable conventional openings (for example, up the front or the back) which allows the garments to be donned quickly; and may also be provided with fly openings.

FIG. 1 shows a body 2 of a chemically protective garment according to a first embodiment of the present invention and comprising a vest portion 4 and shorts portion 6 created together from chemically protective fabric. The body 2 is formed as a single item but is tailored to appear to have a waist band 8 for appearance purposes. Alternatively, the body could be formed in two separate parts 4, 6 in which case item 8 would be the actual waist band, where the vest portion 4 and shorts portion 6 were sealingly engaged. Body 2 comprises a torso portion 10, arm portions 12 and leg portions 14. The body also includes a collar portion 16 with a zip opening 17, which extends upwardly to allow the fitting of head protection. The collar could be formed of chemically protective fabric or from of improved thermal properties fabric according to different embodiments.

The wearer has a torso, an upper arm 18 which extends from the shoulder to the elbow 20 and a forearm 22 which extends from the elbow to the wrist 24. The wearer also has hands 26. The wearer has legs which include upper legs 28 which extend from the hips to the knee 30 and lower legs 32 extending from the knee to the ankle 34. The wearer also has feet 36 (in this case covered by socks 38). The wearer also has a head 40 and neck 42.

In this first embodiment, the arm portions 12 of the garment body extend to the middle of the upper arms 18 and terminate above the elbow. In other embodiments, the arm portions may extend further down and terminate below the elbow, for example at the middle of the forearm, should longer sleeves be required. Thus, in this first embodiment, the lower half of the upper arms and the whole of the forearm is free of any sort of covering material, so as to improve heat loss in the “dressed down” state.

Analogously, the leg portions 14 of the garment body extend about half way down the upper legs of the wearer, leaving the lower part of the upper legs 28 and the whole of the lower legs 32 free of any kind of covering material, once again so as to maximise heat loss from the soldier in the dressed down state.

The garment may be completed by donning chemically protective removable sleeves and removable leggings as will be described in FIG. 8.

FIG. 2 shows a garment body 2 according to a second embodiment; and is similar to the first embodiment except that the leg portions 14 of chemically protective fabric extend down to the ankle 34 of the wearer. The garment may be completed by donning removable sleeves, which incorporate glove portions; or by donning removable sleeves and separate chemically protective gloves.

FIG. 3 shows a garment body 2 according to a third embodiment; and is similar to the first embodiment except that the leg portions 14 of the garment body are provided with leg extensions 44, which extend from the leg portion 14 to the ankle 34 of the wearer. The leg extensions are formed of a lightweight material of improved thermal properties compared to the chemically protective fabric of the garment body (e.g. conventional BDU fabric) and therefore allow for improved heat loss from the legs of the wearer. Although for the purposes of illustration, the leg portions of 14 and the leg extensions 44 are shown as separate items, it is preferred that any visual difference is minimised. This may be achieved by using the same face fabric for the chemically protective fabric as for the leg extensions.

Again, the garment is completed by donning removable sleeves and gloves (either separate or integral). Chemical protective boots or bootees are also donned.

FIG. 4 shows a garment body 2 according to a fourth embodiment; and is similar to the third embodiment, except that arm extensions 46 in lightweight conventional BDU fabric are provided in addition to the leg extensions 44. The arm extensions 46 extend from the end of the arm portions 12 to the wrist 24 and again any visual discontinuity is to be avoided. Thus, a common face fabric may be employed for the garment body and the arm and leg extensions. The extensions 44, 46 give the wearer the appearance of full battlefield dress uniform, whilst providing chemical protection in the body area.

The chemical protective garment is completed by donning removable sleeves (and separate or integral gloves) and removable leggings (and separate or integral boots/bootees).

FIG. 5 shows the garment body 2 according to the fourth embodiment, where the lightweight arm extensions 46 are rolled up. Rolling up the sleeves of the lightweight arm extensions is easily achieved, but is difficult or impractical in the case of thicker chemically protective fabric. This allows the wearer to adjust his heat loss and thermal comfort, by rolling up his arm extensions. In the drawing, they are shown rolled up above the elbow, but could clearly be rolled up to any chosen extent.

FIGS. 6, 7 and 8 show fully assembled chemical protective garments according to the present invention. FIG. 6 includes the body of the first embodiment; whilst FIGS. 7 and 8 include the body of the fourth embodiment, which includes arm and leg extensions.

In addition, FIGS. 6, 7 and 8 show chemical head protection comprising a hood 50 and respirator 52 fitted around its circumference 54 to the hood. The hood includes a head portion 56 which covers the wearer's head and includes the circumferential opening for sealingly fitting the respirator; and also includes an integral cowl 58 intended to underlie the corresponding portion of the body surrounding the wearer's neck and so provide a chemical seal. To retain the hood in place, the collar portion 16 of the garment body is closed at zip opening 17 and snugly fits around the hood.

The respirator 52 may be separate or may be integrally formed with the hood.

FIG. 6 shows a chemical protective garment according to the invention, which comprises a garment body 2 according to the first embodiment (i.e. leaving the arms and legs uncovered) but provided with removable sleeves 60 (including integral glove portions 62) formed of chemically protective fabric; and also provided with removable leggings 64 (including integral bootee portions 66). The garment body is split at the waist 8 into separate portions 4, 6 which sealingly overlap in waist region 9 of the garment body. In this embodiment, the wearer has maximum heat loss in the undressed state, where the sleeves and leggings are removed to leave bare arms and legs.

FIGS. 7 and 8 both show garments according to the invention, which employ the garment body of the fourth embodiment (i.e. including arm extensions and leg extensions of fabric of improved thermal property compared with the leg portion.

FIG. 7 employs removable sleeves 60 with integral gloves 62, which are fitted over the arm extensions 46; and also removable leggings 64 with integral bootees 66, which are fitted over the leg extensions 44. In this case, when the removable sleeves and removable leggings are removed, the wearer appears to be in full battlefield dress uniform and is able to adjust his heat loss by rolling up his arm extensions (and leg extensions) to uncover his skin.

FIG. 8 is analogous to FIG. 7, except that removable sleeves 60 are employed, which overlap separate chemically protective gloves 70.

The gloves 70 include wrist portions 72, which overlap the arm extensions 46. The removable sleeve 60 also sealingly overlaps the wrist portion 72 of the glove 70. Also, separate leggings 64 overlie the leg extensions 44 and sealingly overlap ankle portion 76 of separate chemically protective bootee 74.

FIG. 9 shows the fitting of removable sleeve 60 to the garment body of the first, second or third embodiments (i.e. no fabric extensions), but where the wearer is wearing a protective glove 70. A Velcro (trademark) flap 78 is provided on the sleeve 60 for engagement with a Velcro (trade mark) pad 80 attached to the arm portion 12 of the garment body.

FIG. 10 shows the sleeve fitted to the arm portion and overlapping in region 82 to assist chemical protection thereof.

FIGS. 11 and 12 show an analogous embodiment to FIGS. 9 and 10, but where the removable sleeve 60 is fitted underneath the arm portion 12, overlapping in region 82, in order to prevent the ingress of noxious chemicals in liquid form.

FIGS. 13 and 14 analogously show the fitting of a sleeve 60 with integral glove portion 62 to a garment body 2 according to the first, second or third embodiments.

FIGS. 15 and 16 show an analogous embodiment to FIGS. 13 and 14, but where the removable sleeve 60 is fitted underneath the arm portion 12 in order to provide protection against the ingress of chemical liquid.

FIGS. 17 and 18 show removable sleeves fitted to a garment body according to the fourth; or first, second and third embodiments respectively.

FIG. 19 shows an alternative embodiment of the prevent invention, wherein the garment body 2 lacks any arm portions and is in the form of a gillet. In this case, the removable sleeve 60 is fitted directly onto the torso 10 of the garment body and overlaps the torso in overlap region 83. A Velcro (trade mark) pad 80 is provided on the torso and engages a corresponding pad 81 on the inside of the removable sleeve for attaching the sleeve to the body.

FIGS. 20 to 28 show the fitting of removable leggings of chemically protective fabric to the garment body.

In particular, FIGS. 20 and 21 show the fitting of removable leggings 64 with integral bootee 66 to a leg portion 14 of the garment body. A Velcro (trade mark) hook and loop fastening flap 80 is provided on the legging for engaging the Velcro (trade mark) pad 82 on the leg portion, and so securing the legging to the leg portion over overlapping region 84.

FIGS. 22 and 23 show an alternative embodiment to FIGS. 20 and 21, where the removable leggings 64 (including bootee 66) are fitted underneath the leg portion 14 to avoid ingress of liquid chemical.

FIG. 24 shows in detail the fitting of leggings shown in FIG. 8.

FIGS. 25 and 26 show the fitting of removable legging 64 to leg portion 14 by means of Velcro (trade mark) fasteners 80, 82 in the case where the wearer will additionally don chemically protective boots over the socks 38.

FIGS. 27 and 28 show an alternative embodiment to FIGS. 25 and 26, where the removable leggings 64 are fitted underneath the leg portion 14 to avoid ingress of liquid chemical.

1. A chemical protective garment comprising:
(a) a body comprising:
a torso portion; and
leg portions extending from the torso portion, said torso portion and said leg portions comprising a chemically protective material;
(b) removable arm sleeves adapted to fit to said body, said arm sleeves comprising a chemically protective material; and
(c) removable leggings adapted to fit said leg portions, said leggings comprising a chemically protective material,
wherein said leg portions of the body cover at least a part of each leg of the wearer.

2. A garment according to claim 1, said body further comprising:
arm portions extending from the torso portion to at most to the middle of the forearm of the wearer, said arm portions comprising a chemically protective material,
wherein at least the lower half of the forearm of the wearer is not covered by said arm portion, and
wherein the removable sleeve is adapted to fit the arm portions of the body.

3. A garment according to claim 1, wherein the body is in a single piece.

4. A garment according to claim 1, wherein the body is in two pieces, which join at the waist.

5. A garment according to claim 1, further comprising arm extensions extending from the garment body to the wrist, said arm extensions comprising a material of improved thermal properties compared to the chemically protective material of the body.

6. A garment according to claim 5, which further comprises leg extensions extending from said leg portions to the ankle, said leg extensions comprising a material having improved thermal properties compared to the chemically protective material of the body.

7. A garment according to claim 5, wherein the material of the arm and leg extensions has a lower thermal resistance than the chemically protective material.

8. A garment according to claim 5, wherein the material of the arm and leg extensions has a lower thermal evaporative resistance than the chemically protective material.

9. A garment according to claim 5, wherein the material of the arm and leg extensions has a higher air permeability than the chemically protective material.

10. A garment according to claim 5, wherein the material of the arm and leg extensions is of lighter weight than the chemically protective material.

11. A garment according to claim ??, which further comprises securing means for securing at least one of the removable sleeve and the removable leggings to the body.

12. A garment according to claim 1, wherein at least one of the removable sleeve and removable leggings overlaps the body.

13. A garment according to claim 1, wherein the body overlaps at least one of the removable sleeve and removable leggings.

14. A garment according to claim 1, wherein the removable sleeve includes a glove portion.

15. A garment according to claim 1, wherein the removable leggings comprise a bootee portion.

16. A garment according to claim 1, wherein the chemically protective material of the leg portions covers the legs of the wearer.

17. A garment according to claim 1, wherein the garment body further comprises an integral hood portion formed of a chemically protective material for protecting the head of the wearer.

18. A garment according to claim 1, further comprising:
(d) a removable hood adapted to be fitted to a neck portion of the garment body, said hood comprising a chemically protective material.

19. A garment according to claim 18, wherein the hood includes a cowl portion′ for underlying the neck portion of the garment body.

20. A garment according to claim 19, wherein the neck portion of the garment body comprises a closable collar, which is closable around the neck portion of the hood.

21. A garment according to claim 20, further comprising a respirator.
